(19) United States
(12) Patent Application Publication
(10) Pub. No.: US 2011/0238471 A1
(43) Pub. Date: Sep. 29, 2011

(54) Generic Universal Rewards Loyalty Card

(76) Inventor: John Richard Trzcinski, Mashpee, MA (US)

(21) Appl. No.: 12/730,250

(22) Filed: Mar. 24, 2010

(51) Int. Cl. G06Q 30/00

(52) U.S. Cl. 705/14.23; 705/14.3; 235/380

(57) ABSTRACT

A method and system for enabling a customer to participate in a plurality of rewards programs, operated by a plurality of retailers, using the same generic loyalty card. The customer submits registration information, and is issued a card which may be used to participate in rewards programs with any of a plurality of retailers. The generic loyalty card may be used for rewards programs in either an in-store visit or an online transaction with the retailer. Additional registration information may be submitted using a customer mobile device.

### FIELD OF THE DISCLOSURE

This disclosure relates to retail merchandising and customer relationship management, and more particularly to customer loyalty and reward programs.

### BACKGROUND OF THE DISCLOSURE

In order to build and maintain customer loyalty, many retailers offer customers a “loyalty card” or “rewards card.” In general, each retailer operates a separate customer loyalty program, offering discounts, promotions and the like to a customer visiting that retailer with the corresponding loyalty card. A customer belonging to loyalty programs with multiple retailers and wishing to visit multiple stores therefore needs to carry multiple cards.

For greater customer convenience, it is desirable to implement a system where the customer needs to carry only a single card which is usable in multiple stores with different loyalty programs.

### SUMMARY OF THE DISCLOSURE

The present disclosure provides a method and system for enabling a customer to participate in a plurality of rewards programs, operated by a plurality of retailers, using the same loyalty card.

According to a first aspect of the disclosure, a method comprises receiving registration information from a customer; issuing a card to the customer in response to receiving that information; receiving information encoded on the card and information relating to a customer transaction with a retailer (any one of a plurality of retailers); and offering to the customer participation in a rewards program operated by that retailer in accordance with the registration information. The customer is thereby enabled to participate in a plurality of rewards programs, in accordance with the registration information and in accordance with use of a single card (the generic loyalty card). The generic loyalty card may be used for rewards programs in either an in-store visit or an online transaction with the retailer. Additional registration information may be received from a customer mobile device.

According to another aspect of the disclosure, a system includes a server configured to: receive registration information from a customer relating to rewards programs operated by a plurality of retailers; receive information encoded on a card issued to the customer in accordance with the registration information and information relating to a customer transaction with any one of the plurality of retailers; and process the transaction information to track customer activities with respect to the rewards programs. The system also includes a data storage device configured to store the above-described information. The server and the data storage device may be operated by an entity responsible for issuing the card to the customer.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 schematically illustrates a customer submitting a single application for multiple reward programs, according to an embodiment of the disclosure.

FIG. 2 schematically illustrates a universal loyalty card being used by a customer in a plurality of stores, according to an embodiment of the disclosure.

FIG. 3 schematically illustrates a system for adding a retailer to a customer's loyalty card via mobile software on the customer's cell phone, according to a further embodiment of the disclosure.

### DETAILED DESCRIPTION

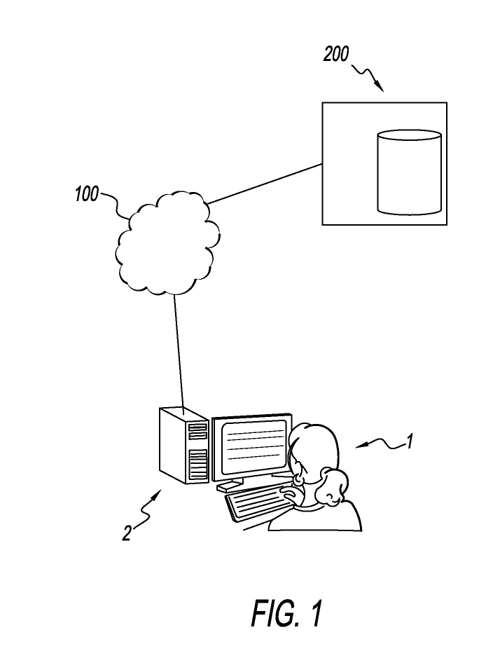

In accordance with the disclosure, a customer fills out and submits a single reward program application for programs operated by multiple retailers. In an embodiment (see FIG. 1), customer 1 uses a personal computing device 2 to submit registration information to obtain a generic loyalty card. The registration information includes identifying information (e.g. name and address) and other information used generically by all the retailers (e.g. size of household). This information is transmitted via the Internet 100 to a system 200 which tracks the customer's activities with respect to rewards programs at all of the different retailers. System 200 is “centralized” in the sense that this system manages information from the customer and all of the retailers in accordance with the customer's use of a single, generic loyalty card. System 200 may be operated by an independent entity to which the retailers have subscribed; the independent entity would be responsible for issuing the cards and maintaining the integrity of the customer data.

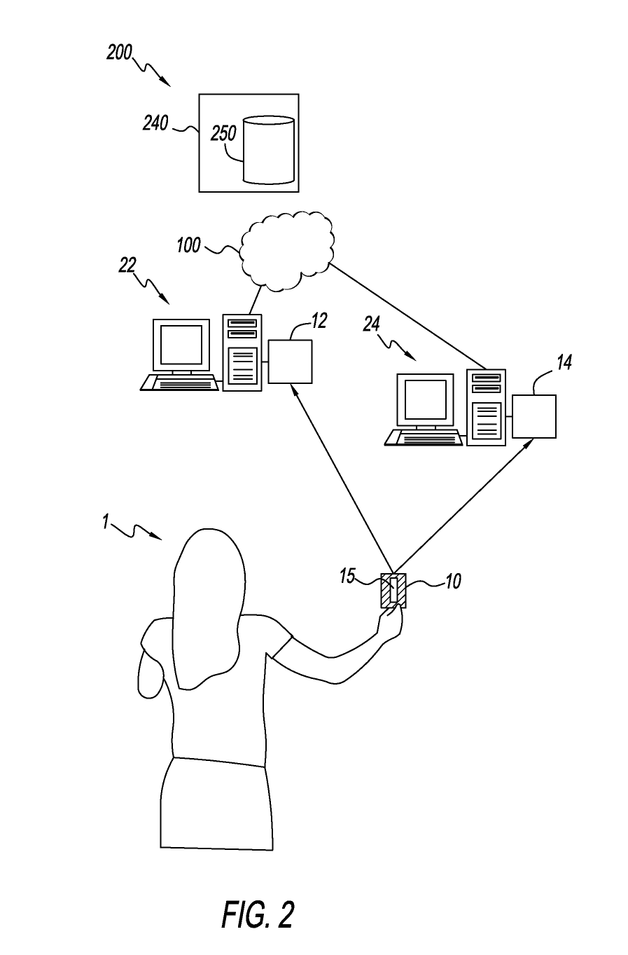

In an embodiment, as shown in FIG. 2, customer 1 may present a single loyalty card 10 at stores belonging to different retailers. Each retailer has a separate in-store system 22, 24 which includes a card reader 12, 14 respectively. At each different store, the card reader obtains information encoded on a memory device 15 integral with the card. Memory device 15 is typically on a magnetic strip which may be coupled to a memory chip on or in the card. In an embodiment, memory 15 has identifying information generic to all the different retailers (e.g. customer name and address), and also has a portion with information specific to each retailer's loyalty program (e.g. place and time of last visit, amount spent during last visit, amount spent year to date, amount spent per individual store). Alternatively, memory 15 may have separate portions for each retailer, with each portion containing both the identifying information and that retailer's specific loyalty program information.

During the customer's store visits, the universal card 10 is used as conventional cards—that is, typically being swiped through readers 12, 14 with information relative to rewards. Data relating to the customer's use of the card (tracking date and time of the store visit, amount of purchase, etc.) is transmitted to centralized system 200 over Internet 100. As shown in FIG. 2, system 200 may include a server 240 with internal data storage device 250 for storing customer information and reward program information. Server 240 executes software designed to support uses of card 10 with multiple retailers. From the centralized system, information is transmitted to the retailers so that the relevant rewards are made available to the consumer. More generally, system 200 may receive information relating to any transaction between the retailer and the customer, whether a personal store visit or an online purchase by the customer at the retailer's Web site. (In an online visit to a retailer, the customer submits human-readable information from the card 10, rather than having the card read or swiped, as is understood in the art.)

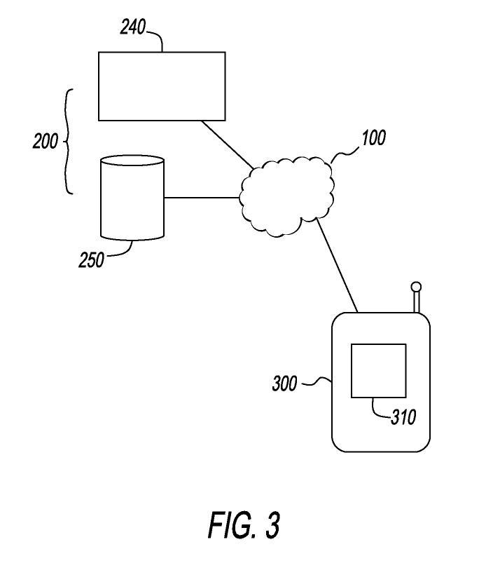

In an additional embodiment, shown schematically in FIG. 3, the customer uses a portable device 300 (e.g. a cell phone) having mobile software 310 to manage his registration with the generic reward program. In this embodiment, a mobile software application for the cell phone 300 permits the customer to communicate with system 200 to update customer information. In particular, the customer may add a new retailer so that he may use his generic loyalty card 10 on his first visit to a store operated by that retailer.

This invention permits a customer to use a single card for rewards programs in all the various stores for which he has registered. The cell phone application, as described above, offers a convenient way to connect the customer's generic loyalty card with additional stores that offer a rewards program. In addition to customer convenience, the disclosure offers an environmental benefit by making it unnecessary to produce and circulate multiple cards.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. A method comprising:
receiving registration information from a customer;
issuing a card to the customer in response to receiving the registration information;
receiving information encoded on said card and information relating to a customer transaction with a retailer, said retailer being any one of a plurality of retailers; and
offering to said customer participation in a rewards program operated by said retailer, in accordance with said registration information;
thereby enabling said customer to participate in a plurality of rewards programs, in accordance with said registration information and in accordance with use of the same said card.

2. A method according to claim 1, further comprising making rewards available to the customer, in accordance with said rewards program.

3. A method according to claim 1, wherein said step of receiving information encoded on said card is performed using a card reading device during a visit by said customer to said retailer.

4. A method according to claim 1, wherein said step of receiving information encoded on said card comprises receiving information submitted by the customer during an online transaction with said retailer.

5. A method according to claim 1, wherein the information encoded on the card is stored in a memory device disposed on the card.

6. A method according to claim 5, wherein said memory device stores information generic to all of said rewards programs and information specific to each rewards program for which said customer is registered.

7. A method according to claim 1, further comprising receiving additional registration information from a customer mobile device.

8. A method according to claim 7, wherein said additional registration information relates to a rewards program operated by a retailer having no previous transaction with said customer, thereby enabling said customer to participate in said rewards program in a first transaction with said retailer.

9. A system comprising:
a server configured to
receive registration information from a customer; said registration information relating to rewards programs operated by a plurality of retailers,
receive information encoded on a card issued to the customer in accordance with said registration information and information relating to a customer transaction with a retailer, said retailer being any one of said plurality of retailers, and
process said information relating to the customer transaction to track customer activities with respect to said rewards programs; and
a data storage device configured to store said registration information, said information encoded on said card, said information relating to the customer transaction, and information relating to said rewards programs.

10. A system according to claim 9, further comprising a plurality of card reading devices located at each of said plurality of retailers.

11. A system according to claim 9, wherein said server and said data storage device are operated by an entity responsible for issuing said card.

12. A method according to claim 9, wherein said server is configured to receive additional registration information from a customer mobile device.
